(19) United States
(12) Patent Application Publication
(10) Pub. No.: US 2024/0335746 A1
(43) Pub. Date: Oct. 10, 2024

(54) Systems and Methods for Incremental Dynamic Loading of Game Assets

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/630,409

(22) Filed: Apr. 9, 2024

Related U.S. Application Data
(60) Provisional application No. 63/495,205, filed on Apr. 10, 2023.

(51) Int. Cl. A63F 13/52

(52) U.S. Cl. CPC A63F 13/52; A63F 2300/6615

(57) ABSTRACT

The systems and methods described herein provide techniques for performing fast, incremental, dynamic loading of game assets. A client computer system may be configured to receive updated game state data from a game server and request game assets as needed based on the game state data. The game server may make game assets available for download by the client computing system in the form of downloadable resource comprising, for example, mesh data and texture data. The mesh data and the texture data may be organized within the downloadable resource based on levels of detail (LODs) and provided as a progressive stream. As data related to a game asset is downloaded from the game server, the client computer system may be configured to update the version of the game asset rendered within the virtual scene to incrementally improve the quality of the game asset until it reaches a target LOD.

### RELATED APPLICATIONS

This application claims priority to U.S. Provisional Application No. 63/495,205, entitled “Method for Fast Incremental Dynamic Loading of Game Assets,” filed on Apr. 10, 2023, the content of which is hereby incorporated herein by reference in its entirety.

### FIELD OF THE DISCLOSURE

The systems and methods described herein relate to improved techniques for rendering computer-generated three-dimensional models for video games.

### BACKGROUND

In three-dimensional online games, various game assets are frequently used to express computer-generated graphics or three-dimensional models. Game assets include different three-dimensional objects such as characters, items, cars, furniture, buildings, or other structures. Most of the time, game assets are incorporated into the three-dimensional online games and are downloaded when players decide to purchase games. As the complexity and detail of game assets in online games increases (for example, to accommodate the use of augmented or virtual reality), maintaining an adequate download and loading-to-screen time becomes increasingly difficult. Indeed, as the size of the files needed to render game assets increases, so too does transmission data size, transmission time, memory usage, and rendering time.

In computer graphics, different levels of detail are frequently used to express the complexity of computer-generated graphics or three-dimensional models. A level of detail (or “LOD”) can be described as one or more three-dimensional models, with a certain number of triangles or vertices used, and maybe a certain texture applied. Different LODs of the same three-dimensional object may have a different number of triangles/vertices, and different resolutions and/or image quality of the textures. The tradeoff when using LODs is in the quality of a rendered three-dimensional object versus resources needed to describe and/or render the three-dimensional object. For example, a lower or minimized LOD requiring less data may be used as a placeholder while a three-dimensional model for an object is still loading to improve the experience of the user. A lower or minimized LOD may also be used when the object appears further away from the camera (or viewpoint) within a virtual environment. In contrast, a higher LOD may be needed as the distance between the user and the object decreases (e.g., when the object appears closer to the user in the virtual environment). In gaming applications (such as in video games in augmented or virtual reality), three-dimensional digital assets rendered within the game may include scenes comprising trees and buildings as well as characters, all with potentially different LODs. The LODs for those digital assets may be determined based on the three-dimensional model and/or scenes in which the digital assets are situated.

In light of the foregoing, a technique that utilized different LODs when dynamically and incrementally loading game assets in order to reduce download time and/or rendering time would represent an improvement over existing systems.

### SUMMARY OF THE DISCLOSURE

This disclosure relates to systems and methods for performing fast, incremental, dynamic loading and/or rendering of game assets. In various implementations, a client computer system may receive periodic updates from a game server, for example, as part of a subscription. The periodic updates, for example, may include updated game state data, along with a list of one or more game assets to be rendered within a virtual scene. In various implementations, the game server may make game assets available for download by the client computing system in the form of downloadable resources comprising, for example, mesh data and texture data. In various implementations, based on the updated game state data, the client computing system may be configured to issue a request for a downloadable resource corresponding to a game asset identified in the updated game state data. In various implementations, the request for the downloadable resource may comprise a range request, such as an HTTP range request. For example, in some implementations, a range of the range request may be determined based on the size map included in the updated game state data. In various implementations, the client computing system may be configured to download data from the game server related to a requested game asset. In various implementations, the game asset may comprise a computer-generated three-dimensional object. In various implementations, the mesh data and the texture data may be organized within the downloadable resource based on levels of detail (LODs). In various implementations, the downloadable resource may comprise a progressive stream in which a mesh stream corresponding to the mesh data and a texture stream corresponding to the texture data are interleaved together. In some implementations, the mesh data and the texture data may be organized within the downloadable resource such that mesh data and texture data for a lower-quality LOD come before mesh data and texture data for a next higher-quality LOD.

In various implementations, a game asset downloaded from the game server may be provided by the game server as a downloadable resource comprising a set of game assets associated with a lower-quality LOD that are specific to one location. In some implementations, one or more game assets may be pre-loaded that are not within a virtual scene currently rendered or to be rendered but the updated game state data indicates that the one or more game assets are likely to appear. In some implementations, game assets may be provided by the game server as a downloadable resource that includes redundant data that enables a client computing system to reconstruct data in the downloadable resource not successfully received. In some implementations, the game server may offer both a CPU-intensive version of the downloadable resource and a traffic-intensive version of the downloadable resource. In such implementations, the CPU-intensive version of the downloadable resource may include one or more AVIF-encoded images, whereas the traffic-intensive version of the downloadable resource does not include any AVIF-encoded images. In some implementations, one of the CPU-intensive version of the downloadable resource and the traffic-intensive version of the downloadable resource may be selected for downloading based on a number of currently outstanding requests to decode downloadable resources.

In various implementations, the client computer system may be configured to render the game asset based on the data downloaded from the game server. In some implementations, a client computer system may be configured to begin rendering one or more game assets “immediately” after receiving an updated game state. For example, in various implementations, generic game assets for one or more three-dimensional objects may be stored prior to receiving the updated game state data. In some implementations, a game asset may be rendered based on the updated game state data using the base mesh and the base texture. In such implementations, data later downloaded from the game server may be used to render an updated version of the game asset rendered using the base mesh and the base texture. In some implementations, data related to a game asset may be downloaded in a progressive stream. In such implementations, the rendering of a game asset may be delayed until the data downloaded from the game server related to the game asset satisfies a minimum LOD. In some implementations, the minimum LOD may be selectable by a user via the client computer system. In some implementations, a downloadable resource may comprise a progressive stream and the data downloaded from the game server may include texture data. In such implementations, the texture data may be recompressed into a GPU-supported format texture and/or the texture may be resized after rendering the game asset based on the data downloaded from the game server. In some implementations, game assets downloaded from the game server may be cached. For example, in some implementations, the game asset may be partially-cached such that only a portion related to a progressive stream is cached. In other implementations, the game asset may be cached as an asset in a GPU-friendly format.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to enable fast, incremental, dynamic loading of game assets, according to one or more aspects described herein;

FIG. 2 depicts a block diagram of an example downloadable resource for providing a game asset, according to one or more aspects described herein; and

FIG. 3 depicts a diagram of an example of a method for performing fast, incremental, dynamic loading of game assets, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

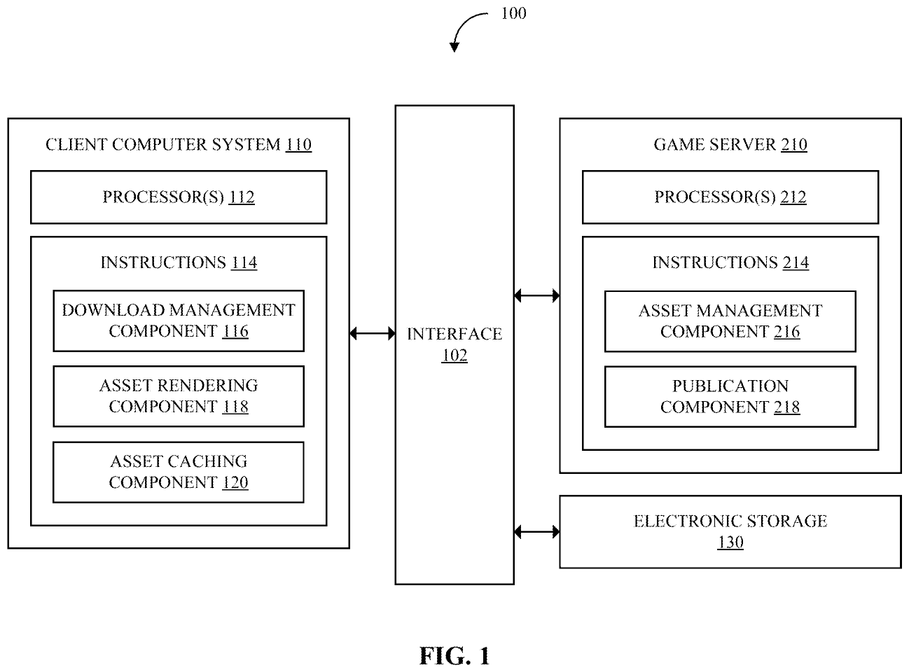

FIG. 1 illustrates an example of a system 100 configured to enable fast incremental dynamic loading of game assets, according to one or more aspects described herein. In various implementations, system 100 may include one or more of an interface 102, at least one client computer system 110, electronic storage 130, a game server 210, and/or other components. In various implementations, client computer system (or device) 110 may comprise a game client computing system (or device). In some implementations, client computer system 110 may be configured to receive instructions and game state data related to an online game comprising three-dimensional virtual scenes from game server 210. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors 212 (also interchangeably referred to herein as processor(s) 212, processor 212, or processors 212 for convenience), computer readable instructions 214, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

In various implementations, processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of download management component 116, asset rendering component 118, asset caching component 120, and/or one or more other computer program components, and computer readable instructions 214 may include one or more of asset management component 216, publication component 218, and/or other computer program components. As used herein, for convenience, the various computer readable instructions 114, 214 will be described as performing an operation, when, in fact, the various instructions program the processor(s) 112, 212 (and therefore client computer system 110 or game server 210) to perform the operation.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication”, and (c) whenever published game state is updated (for example, as a result of user inputs sent to the game server and/or as a result of simulation), game server 210 may send the update to the game state to all the current “subscribers”. In response to the updated game state data and/or as otherwise necessary, client computing system 110 may be configured to download game assets from game server 210 for rendering within virtual scenes of the game. To that end, in various implementations, asset management component 216 may be configured to generate, organize, encode, and/or otherwise manage game assets used to render a virtual scene. For example, game assets may comprise the three-dimensional objects that, when rendered, make up a virtual scene in a game.

In various implementations, asset management component 216 may be configured to organize game assets as a set of separate levels of detail (or “LODs”). As used herein, “LOD[0]” may be used to refer to a highest-quality LOD, and “LOD[Last]” may be used to refer to lowest-quality LOD. Accordingly, “LOD[1]” may be used to refer to a second-highest-quality-LOD, and LOD[Last-1] may be used to refer to a second-lowest-quality-LOD, and so forth. In various implementations, each LOD may include glTF JSON, glTF BIN data (including meshes), and one or more textures. In some other implementations, various serializations of LOD data (including, but not limited to, Google Protocol Buffers (a.k.a. protobuf), Flatbuffers, or any other serialization method or protocol) may be used instead of glTF and/or JSON. The JavaScript Object Notation (or “JSON”) file format is a commonly used file format for storing data and is part of the glTF and GLB file formats, which are standard file formats used by three-dimensional applications (e.g., virtual reality (VR), augmented reality (AR), gaming, and/or other three-dimensional applications) to store three-dimensional scenes and models. As described herein, BIN data associated with structured data (e.g., glTF JSON data) may be included within the structured data and/or referenced by the structured data. In some implementations, glTF 2.0 may be used. In some implementations, glTF may not be necessary depending on the purpose of the application. In various implementations, LODs may be generated using one or more techniques described, for example, in U.S. patent application Ser. No. 18/587,095, entitled “SYSTEMS AND METHODS FOR CREATING LEVELS OF DETAIL USING PERCEPTUAL DEGRADATION,” filed Feb. 26, 2024, the content of which is hereby incorporated by reference herein in its entirety.

In various implementations, asset management component 216 may be configured to organize each game asset as a downloadable resource. For example, a downloadable resource may include all of LOD[Last] related data first, all of LOD[Last-1] related data next, then all of LOD[Last-2] related data next, and so on. In some implementations, a downloadable resource may not include LOD[Last] related data as client computer system 110 (or asset rendering component 118 described herein) may use generic assets (or base assets) to render LOD[Last]. For example, client computer system 110 may use generic assets for LOD[Last] as described in U.S. patent application Ser. No. 18/602,575, entitled “SYSTEMS AND METHODS FOR EFFICIENT COMPRESSION OF LOW-RESOLUTION GAME ASSETS,” filed Mar. 12, 2024, the content of which is hereby incorporated by reference herein in its entirety. In such implementations, a downloadable resource may include all of LOD[Last-1] related data first, all of LOD[Last-2] related data next, and so on.

In some implementations, generic (base) assets may include morph targets, and the publication data (the published (or updated) game state) may include morph target percentages. In some implementations, generic (base) assets may include vector graphics, and the publication data (the published (or updated) game state) may include colors. The published morph target percentages and/or colors may be applied to the morph targets and/or vector graphics of the generic (base assets) as described, for example, in U.S. patent application Ser. No. 18/602,575. For example, client computer system 110 may be configured to apply the morph target percentages and/or colors included in a published game state to the morph targets and/or vector graphics, respectively, of a generic (base asset) to produce a model to be rendered. This may enable a variety of models to be rendered “immediately” using only a limited number of generic (base) assets. In one non-limiting example, generic (base) assets may include a “normal male” base mesh, and “fat male” and “short male” morph targets, along with vector graphics (such as SVG) for textures corresponding to a t-shirt and pants. Then, upon receiving publication data with numbers “70” and “30,” and colors “yellow” and “blue,” client computer system 110 may be configured to apply 70% “fat male” and 30% “short male” morph targets to “normal base mesh” and the colors “yellow” and “blue” to the respective vector graphics to produce a model representing a rather fat and somewhat short male wearing a yellow t-shirt and blue pants. In various implementations, asset management component 216 may be configured to encode data for game assets for use as a downloadable resource. In various implementations, each LOD may include its own JSON, meshes, textures, and/or other components. In various implementations, asset management component 216 may be configured to interleave different progressive streams. For example, each of the LODs may include a JSON stream, a mesh stream, a diffuse texture stream, a normal texture stream, and/or other stream. To generate such interleaved streams, asset management component 216 may split an original progressive stream into LOD-based portions when LOD resources are formed. Then, asset management component 216 may combine (or join) portions of the stream to effectively form a final progressive stream. In some implementations, asset management component 216 may combine (or join) portions of the stream in a virtual manner. For example, asset management component 216 may enable portions of the stream to be combined by providing an application programming interface (API). Such an API may be configured to allow bytes to be read from a virtually joined stream without actually generating a contiguously joined stream in a memory or a disk.

In various implementations, data for each LOD may include glTF JSON, glTF BIN data, and/or one or more textures. In some other implementations, various serializations of LOD data (including, but not limited to, Google protobuf, Flatbuffers, or any other serialization method or protocol) may be used instead of glTF and/or JSON. In some implementations, glTF JSON data, game state data, and/or serialization data may be compressed using one or more techniques described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety. In other implementations, glTF JSON data and/or serialization data may be compressed using one or more standard compression methods, such as deflate or Zstandard (zstd) compression. In some implementations, the glTF BIN data, game state data, and/or serialization data may be compressed using one or more techniques described in U.S. patent application Ser. No. 18/438,702 and/or using one or more standard compression methods, such as the Draco compression method or the Meshopt compression method. In some implementations, the textures may be represented by a portion of the progressive stream that is necessary to achieve desirable texture quality for a specific LOD.

In some implementations, the progressive stream may be prepared using a JPEG-based progressive stream (such as JPEG, JPEG2000, JPEG XR, or JPEG XL). In some implementations, the texture portion of the LOD data may include target pixel width/height of the texture. Note that the use of a non-GPU-supported texture format (i.e., not supported by GPU), such as JPEG of AVIF, even to transfer textures over the network, may be uncommon for games. Rather, more often than not, games prefer to use GPU-supported formats both for distribution and transfer. In contrast with such common practices, some of the implementations according to the present disclosure may use non-GPU-supported textures (such as AVIF textures, JPEG-based textures, or textures encoded using custom encoding and/or compression formats) for transfer purposes, and then convert them to GPU-friendly format on the client computer system 110.

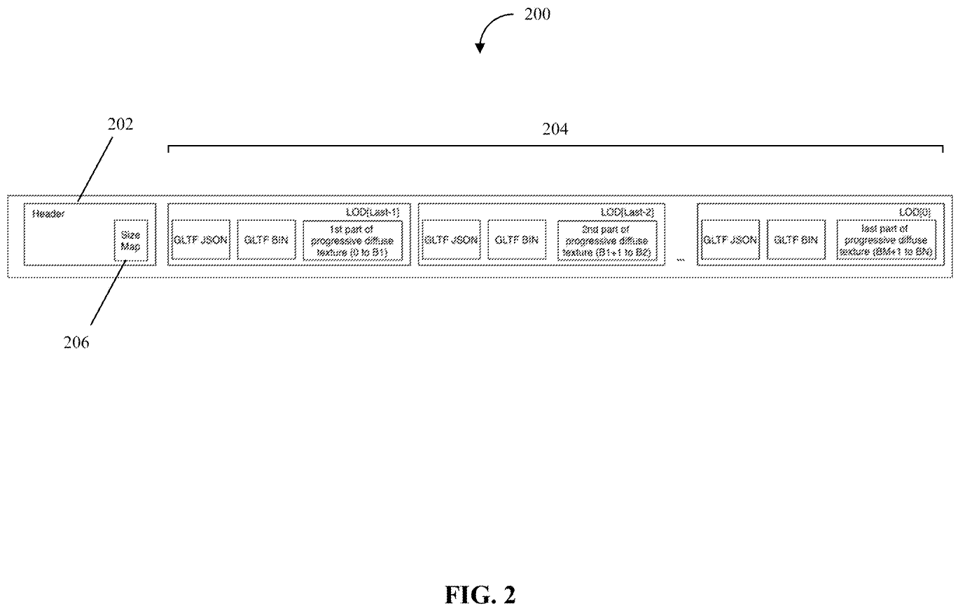

To illustrate a downloadable resource for a game asset organized as separate LODs, FIG. 2 depicts a block diagram of downloadable resource 200 for providing a game asset, according to one or more aspects described herein. Specifically, FIG. 2 depicts a downloadable resource 200 for a texture. For example, asset management component 216 may have a progressive image stream for a texture and obtain information indicating that B₁ bytes are required to render textures of LOD[Last-1], B₂ bytes to render textures of LOD[Last-2], and so on. As depicted in FIG. 2, downloadable resource 200 may include a stream header 202 and sequence of levels of detail (or LODs) 204. In various implementations, stream header 202 may include a size map 206. In various implementations, sequence of data representing LODs 204 may include LOD[Last-1], LOD[Last-2], and so on to LOD[0]. For example, the sequence of data representing LODs 204 may include data for LOD[Last-1] (including compressed glTF JSON for LOD[Last-1], compressed glTF BIN for LOD[Last-1], and a portion of the progressive texture stream from 0 to B₁), data for LOD[Last-2] (including compressed glTF JSON for LOD[Last-2], compressed glTF BIN for LOD[Last-2], and a portion of the progressive texture stream from B₁+1 to B₂), and so on, including data for LODs up to LOD[0] (including compressed glTF JSON for LOD[0], compressed glTF BIN for LOD[0], and a portion of the progressive texture stream from B_{M}+1 to B_{N}). As depicted in FIG. 2, downloadable resource 200 may not include “LOD[Last],” which may be used to denote a lowest-quality LOD, as generic assets (or base assets) stored on (or already accessible by) client computer system 110 may be used as LOD[Last], as described herein. Note that whenever we are speaking about glTF or JSON and/or glTF BIN, other formats containing similar information may be used, including, but not limited to, Google protobuf, FlatBuffers, custom encodings, and/or other formats/techniques now known or future developed.

In some implementations, downloadable resource 200 may include one or multiple textures in an interleaved stream format. For example, the interleaved stream may include streams for diffuse textures, normal textures, and/or PBR textures (such as, for example, metallic, roughness, or occlusion textures). In some implementations, texture streams of downloadable resource 200 may start not from LOD[Last-1]. In other words, texture streams of the downloadable resource 200 may start from later LODs. For example, in some implementations, normal textures may skip lower LODs and start from higher LODs.

In some implementations, asset management component 216 may be configured to encode not only textures, but also meshes, in a progressive manner. For example, asset management component 216 may be configured to encode meshes in a progressive manner similar to the progressive texture stream depicted in FIG. 2 and forming downloadable resource 200. In some implementations, asset management component 216 may be configured to encode not only textures and meshes, but also JSON, in a progressive manner. For example, asset management component 216 may be configured to encode JSON in a progressive manner similar to the progressive texture stream depicted in FIG. 2 and forming downloadable resource 200. In various implementations, progressive streams may be created using one or more techniques described in U.S. patent application Ser. No. 18/438,702.

For each of its related resources, downloadable resource 200 may include a LOD size map. Such an LOD size map may include information indicating the LOD number (e.g., LOD[Last-1], LOD[Last-2], etc.) and/or a size of the resource necessary to render the corresponding LOD. In some implementations, a size map may be implemented as a simple sequence of offsets. As depicted in FIG. 2, in some implementations, a size map may be included in header of the downloadable resource 200. In other implementations, size map for the resource may be included in a publication as part of the published data.

In various implementations, publication component 218 may be configured to publish data regarding a current state of the game. In various implementations, publication component 218 may be configured to use mechanisms such as Unity sync variables, UE4 variable replication, or global-mq publications. In various implementations, a publication may include a current level, list of items and/or non-player characters (NPCs) with identifiers for their three-dimensional models and/or their coordinates. In some implementations, a publication may be compressed using compression methods for structured data. For example, a given publication may be compressed using one or more techniques described in U.S. patent application Ser. No. 18/438,702. In some implementations, a publication may include compressed representations of objects. For example, representations of objects may be identifiers of generic assets (or objects) compressed using one or more techniques described in U.S. patent application Ser. No. 18/602,575.

Referring now to client computer system 110, download management component 116 may be configured to implement the dynamic downloading of game assets to be rendered. As an initial matter, in various implementations, client computer system 110 may not store, have access to, or otherwise possess game assets except generic assets (or objects) or pre-cached (or previously-cached) game assets. For example, client computer system 110 may only have generic objects as described in U.S. patent application Ser. No. 18/602,575. Instead of already having all game assets, most game assets are made available for download over the Internet. For example, in some implementations, game assets may be available over HTTP-over-QUIC (such as HTTP/3) and/or over HTTP/2. In some implementations, game assets may be hosted on a Content Delivery Network (CDN) or on a Web Server (where any of CDN and Web Server may use, for example, HTTP/2 or HTTP/3), and client computer system 110 may issue requests to receive game assets. For example, in some implementations, download management component 116 of client computer system 110 may be configured to request game assets (or resources) from a CDN. If a CDN is not available (or accessible), download management component 116 may access a Web Server directly instead. When requesting/downloading game assets (or resources), QUIC or any UDP-based protocol may be useful to restrict Head-of-Line Blocking effects to one single stream because, with TCP-based protocols, Head-of-Line Blocking affects all the streams. In some implementations, to restrict Head-of-Line Blocking effects, download management component 116 may be configured to issue each resource request over a separate QUIC (and/or HTTP/3) stream. In some implementations, to improve handling of lost packets during download, download management component 116 may be configured to use one or more techniques described in U.S. patent application Ser. No. 18/616,967, entitled “SYSTEMS AND METHODS FOR IMPROVING ASSET DOWNLOAD TIME USING FORWARD ERROR CORRECTION,” filed Mar. 26, 2024, the content of which is hereby incorporated by reference herein in its entirety.

In various implementations, download management component 116 may be configured to implement requests in the form of HTTP range requests. An HTTP range request asks a server to send only a portion of an HTTP message back to a client. For example, download management component 116 may be configured to implement requests in the form of HTTP range requests, as described in the Internet Engineering Task Force (IETF) Request for Comment 9110, entitled “HTTP Semantics” (hereinafter referred to as “RFC9110”). In various implementations, download management component 116 may be configured to allow the HTTP client to communicate its preferences for how an upstream server prioritizes responses to its requests, and also allow a server to hint to a downstream intermediary (if present) how its responses should be prioritized when they are forwarded. In some implementations, HTTP range requests may be HTTP-over-QUIC range requests. In other implementations, HTTP range requests may be HTTP/3 range requests or HTTP/2 range requests. In such implementations, “ranges” in the range requests may be calculated based on a size map. In alternative implementations, download management component 116 may be configured to generate partial requests for resources needed. In some implementations, partial requests may include HTTP range requests and/or FTP's REST command.

In various implementations, download management component 116 may be configured to prioritize the downloading of assets with asset requests assigned an asset priority. In some implementations, download management component 116 of client computer system 110 may be configured to utilize HTTP/2 priorities or HTTP/3 priorities. For example, download management component 116 may be configured to utilize HTTP/2 priorities or HTTP/3 priorities as described in the Internet Engineering Task Force (IETF) Request for Comment 9218, entitled “Extensible Prioritization Scheme for HTTP” (hereinafter referred to as “RFC9218”). In such implementations, download management component 116 may be configured to use HTTP/2 or HTTP/3 priority (derived from asset priority) when sending a request, and issue HTTP/2 or HTTP/3 reprioritization request when asset priority changes.

In various implementations, whenever a new three-dimensional object is encountered in a game (or a published game state), download management component 116 may be configured to perform a number of operations. In various implementations, download management component 116 may be configured to determine whether the object may be excluded. More specifically, download management component 116 may be configured to determine whether the object may be excluded by culling the object, which may include removing from the rendering process those objects that lie completely outside of the camera frustum as rendering such objects may be waste of resources as they are not directly visible). In such implementations, download management component 116 may be configured to determine whether an object may be excluded by Frustum Culling and/or Occlusion Culling. In some implementations, when download management component 116 determines that an object may be excluded, download management component 116 may nonetheless request the object. However, in such implementations, download management component 116 may be configured to lower the priority of a related request.

In various implementations, whenever a new three-dimensional object is encountered in a game (or a published game state), download management component 116 may be configured to calculate a required LOD. For example, download management component 116 may be configured to calculate a required LOD based on a distance from a camera (or viewpoint) associated with the game client. In some implementations, client computer system 110 may be configured to calculate a number of “potentially-obscuring” objects between the camera (or viewpoint) and the object for which the game needs the model. If such potentially-obscuring objects are present, client computer system 110 may be configured to reduce the quality of required LOD (e.g., compared to the required LOD calculated using only the distance from the camera). In some implementations, if the required-LOD is not available in the cache (neither cached as an asset nor partially cached as a resource, each of which are described further herein), download management component 116 may be configured to issue a request for the corresponding resource.

In some implementations, download management component 116 may be configured to split a request into two or more requests with two or more different ranges. For example, if client computer system 110 has lots of resources which are more-than-two-LOD-steps below their required-LODs, download management component 116 may be configured to first request all the parts of the resources needed to bring the rendered three-dimensional objects within two steps from their required LODs (or target LOD). Then, download management component 116 may be configured to request the resources necessary to bring the rendered three-dimensional objects within one step from their required LODs. Only then, download management component 116 may be configured to start requesting resources necessary to bring the rendered three-dimensional objects to their required LODs. In some implementations, this process may be achieved by issuing all requests for different LODs at once, albeit with different asset priorities for individual requests.

In some implementations, download management component 116 may be configured to determine whether a required LOD is already cached as an asset. In such implementations, if the required LOD is already cached as an asset, the required LOD may be served from the cache directly. If the required LOD is partially-cached only for a lower LOD, asset management component 116 may use cached resource to reduce the range of requested data. For example, if LOD[Last-1] is already available in cache, then download management component 116 may be configured to request only the range from LOD[Last-1] to LOD[Last-2] (or whatever LOD is the required LOD). In other implementations, if a progressive stream is being used (either for meshes or for textures), download management component 116 may be configured to implement an incremental loading of resources, with each new LOD requiring a previous one to be decoded.

In some implementations, if identifiers (or IDs) of generic assets (or base assets) are included in a published state, download management component 116 may be configured to start rendering three-dimensional object(s) immediately (i.e., using three-dimensional models constructed from generic assets). For example, as used herein, “immediately” may mean rendering three-dimensional objects based on stored generic assets (or base assets) and/or without waiting for the results of any internet requests related to the rendering of three-dimensional objects. Such immediate rendering may ensure there is no moment when there is a three-dimensional model in view that cannot be rendered at all. In some implementations, in order to ensure a minimum quality of the image, download management component 116 may be configured to delay a start of the rendering until all the assets are available with at least a minimum LOD. For example, the minimum LOD may be pre-defined. In some implementations, the minimum-LOD may be pre-defined for ranges of distance depending on parameters used for calculating a required LOD. In some implementations, a minimum LOD may be selectable by the player. For example, a player may select a minimum LOD from various pre-defined sets of restrictions.

In various implementations, when a new three-dimensional object is encountered in a game (or a published game state) and not already cached as an asset, download management component 116 may be configured to request an asset over the network. In various implementations, download management component 116 may be configured to generate a URL from an ID using some pre-defined rules. In various implementations, download management component 116 may be configured to obtain a range based on size map included in the publication and a required LOD. After receiving a first range (which may start from 0 and may include a resource header), download management component 116 of client computer system 110 may be configured to determine if the size map in the resource header matches the size map in the publication. If there is a mismatch between the resource header and the publication, download management component 116 may be configured to use the size map from the resource header. In some implementations, download management component 116 may be configured to identify temporary inconsistencies between resource header and publication in case of resource updates.

In various implementations, when a response to a request for an asset arrives at client computer system 110, download management component 116 may be configured to start decoding (or decompressing) different parts of the asset, if necessary. In such implementations, decoding and/or decompressing may be performed in separate “worker” threads. When decoding (or decompressing) textures, download management component 116 may be configured to not only decode the texture from the resource format (i.e., the transfer format), but in some implementations may also resize the texture based on a target pixel width/height using appropriate resizing algorithms such as, for example, Lánczos interpolation, bilincar interpolation, bicubic interpolation, fourier-based algorithms, and/or other existing methods. Also, in some implementations, download management component 116 may be configured to encode the texture into a form using GPU-supported compression such as, for example, DXT1, DXT5, BC7, BC6H, ETC, ETC2, PVRTC, and/or ASTC. This may be done, for example, to reduce VRAM requirements for the textures. Ultimately, in such implementations, download management component 116 may be configured to re-compress textures (from resource format into a GPU-supported format).

Once the whole asset or a certain part of the asset (e.g., the part may be a mesh or a texture) has been decoded, asset rendering component 118 of client computer system 110 may be configured to replace previously rendered three-dimensional models of an object with a new three-dimensional model (i.e., including the updated asset or updated portions of the asset) and start using the new model for future renderings (such as renderings of future frames of the game). In various implementations, this technique may be useful for gradually improving the rendering of game assets as additional higher quality assets arrive (and/or are downloaded/decoded) at client computer system 110.

In addition, in some implementations, asset caching component 120 may be configured to cache as an asset the decoded part of the asset (or re-cache the entire asset with the decoded part of asset). In other implementations, asset caching component 120 may be configured to partially-cache the resource for future use.

In various implementations, asset caching component 120 may be configured to use two distinct types of caching: (i) partially-caching and (ii) caching as an asset. Partially-caching may comprise caching the asset in the same format as the downloaded resource. In some implementations, partially-caching may include removing any redundancy added using one or more techniques described in U.S. patent application Ser. No. 18/616,967. In addition, partially-caching may be necessary to reconstruct subsequent LODs, particularly, when the resources include at least one progressive stream. In some implementations, asset caching component 120 may be configured to partially-cache only those parts of the resource that belong to progressive-streams. Caching as an asset, on the other hand, may comprise caching the data of the LOD after decoding. Unlike partially-caching, caching as an asset may be done in GPU-friendly format. Particularly, textures may be stored in GPU-supported format such as ETC2, DXT1, DXT5, and/or other similar formats. In addition, unlike partially-caching, LODs may be independent. For example, even if all LODs are downloaded (i.e., partially-cached resource is actually fully downloaded), asset caching component 120 may still be configured to keep partially-cached resources. In such implementations, asset caching component 120 may be configured to drop not-so-frequently-used LODs while keeping partially-cached resource(s) which are expected to take significantly less space than GPU-friendly format. In some implementations, asset caching component 120 may be configured to re-compress partially-cached resources (or parts of partially-cached resources) to speed up loading from partially-cached form. For example, asset caching component 120 may be configured to re-compress AVIF-encoded textures into JPEG-family form such as JPEG XL.

In some implementations, the decoding of heavily-compressed data may become too CPU-intensive, such that a CPU bottleneck forms at the client computer system 110. To deal with this and provide better asset availability time (where asset availability time is based on both downloading time and decoding time), game server 210 may be configured to provide at least two different versions of a downloadable resource (e.g., comprising a game asset): (i) a CPU-intensive version that uses better compression, but requires more CPU cycles to decode; and (ii) a traffic-intensive version that use less-than-optimal compression, but is faster/easier to decode. In some implementations, download management component 116 may be configured to prompt a user to select which downloadable resources to use (i.e., the CPU-intensive version or the traffic intensive-version). In some implementations, download management component 116 may be configured to select one of the CPU-intensive version or the traffic-intensive version based on the percentage of outstanding requests that are CPU-intensive as compared to the percentage of outstanding requests that are traffic-intensive. For example, download management component 116 may be configured to select one of a CPU-intensive version of a downloadable resource and a traffic-intensive version of a downloadable resource based on the percentage outstanding requests that are CPU-intensive meeting or exceeding a predefined percentage of requests. In some implementations, download management component 116 may be configured to select one of a CPU-intensive version of a downloadable resource and a traffic-intensive version of a downloadable resource based on a number of outstanding requests to decoding worker threads. For example, when a pre-defined threshold is reached, download management component 116 may be configured to stop issuing CPU-intensive requests until a number of outstanding requests drops sufficiently (e.g., to a pre-defined threshold). In some implementations, CPU-intensive resources may include one or more images encoded with CPU-intensive AVIF. For example, download management component 116 may select Traffic-intensive resources to avoid resources including AVIF-encoded textures, having all the images encoded with significantly faster JPEG or JPEG XL.

In various implementations, download management component 116 may be configured to combine (or group together) lower-quality LOD assets (i.e., such as all LOD[Last-1] assets) that are specific to one location (such as a level or entrance) into one single downloadable resource. For examples, lower-quality LOD assets such as buildings, static objects (trees, street objects, furniture), non-player characters (NPCs), and/or other assets may be grouped together in one downloadable resource to reduce the number of requests (such as HTTP requests), which in turn may help to reduce per-request overhead and/or to reduce the overhead necessary to implement forward error correction, such as described in U.S. patent application Ser. No. 18/616,967.

In some implementations, a published game state may include information identifying (or data related to) three-dimensional objects that are likely to appear. In some implementations, the published game state may also include coordinates indicating where those objects are likely to appear. For example, the published game state may include information identifying (or data related to) characters (including both player characters and non-player characters (NPCs)) that are likely to appear. In such cases, download management component 116 may be configured to download and/or begin pre-loading three-dimensional models for those characters such that the models are ready when the characters do indeed appear. In some implementations, download management component 116 may be configured to do the same for other types of objects. In some implementations, download management component 116 may be configured to determine whether to load an object identified as “likely to appear” based on a distance from a camera (or viewpoint) associated with the game client (i.e., within the game). In various implementations, the publishing of “likely to appear” objects may be implemented via communication between game server 210 and other server-side-entities-which-publish-adjacent-levels. It is noted that “adjacent” referred herein may be levels from which such new objects can appear according to game logic and/or graph representing inter-level connections. In various implementations, when likely-to-appear object(s) become actually-rendered object(s), asset management component 216 may be configured to use a manipulation operator to move the element (i.e., the object element or array element) to a different place within the structured data. For example, asset management component 216 may be configured to use a manipulation operator to move the element (i.e., the object element or array element) to a different place within the structured data as described in U.S. patent application Ser. No. 18/438,702.

In various implementations, download management component 116 may be configured to cancel outstanding requests. For example, when a required LOD for an object has changed (or if the object went completely out of scope or view), download management component 116 may be configured to cancel related outstanding requests. In some implementations, cancellation may be implemented by removing asset request from a priority queue of requests. In particular implementations, when an HTTP/2 or HTTP/3 request has already been issued, download management component 116 may additionally be configured to cancel a respective HTTP/3 or HTTP/2 request.

In various implementations, download management component 116 may be configured to re-prioritize outstanding requests. For example, when a required LOD for an object has changed, download management component 116 may be configured to re-prioritize related outstanding requests. In some implementations, re-prioritization may be implemented by changing priority of asset request within a priority queue of requests. In particular implementations, when an HTTP/2 or HTTP/3 request has already been issued, download management component 116 may additionally be configured to issue a HTTP/2 or HTTP/3 re-prioritization request.

In various implementations, client computing system 110 may be implemented as a web-based client computer system using, for example, one or more of HTML5, JavaScript, wasm, and/or WebGL. In some implementations, system 100 may be configured to use WebRTC as an underlying transport layer for subscriptions and/or downloads, for example, in lieu of HTTP and/or QUIC.

In some implementations, normal textures (or normal maps) may be included in an LOD (or downloadable resource) for a game asset, in which case asset management component 116 may be configured to compress such normal textures, for example, using techniques described in U.S. Patent Application No. 18/425,130, entitled “SYSTEMS AND METHODS FOR IMPROVING COMPRESSION OF NORMAL MAPS,” filed Jan. 29, 2024, the content of which is hereby incorporated by reference herein in its entirety. In some implementations, different textures may be included in an LOD (or downloadable resource) for a game asset (including normal, diffuse, and/or types of textures), and regardless of the type of texture, asset management component 116 may be configured to compress one or more textures, for example, using techniques described in U.S. patent application Ser. No. 18/425,525, entitled “SYSTEMS AND METHODS FOR IMPROVING COMPRESSION OF 3D TEXTURES USING UNMAPPED PIXELS,” filed Jan. 29, 2024, the content of which is hereby incorporated by reference herein in its entirety.

In some implementations, system 100 may be configured to utilize Physically Based Rendering (PBR) for materials within LOD resources.

In some implementations, download management component 116 may be configured to detect when HTTP/3 is not available on the server-side (e.g., at game server 210), or when HTTP/3 packets do not reach the server-side and/or client-side. In such cases, download management component 116 may be configured to switch back to HTTP/2. If HTTP/2 is not available (or successful), download management component 116 may further be configured to switch back to HTTP/1.1 and to HTTP/1.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor(s) 112, information received remotely, and/or other information that enables system 100 to function properly. For example, electronic storage 130 may store standard three-dimensional meshes or models, information relating to one or more three-dimensional meshes or models, one or more meshes, one or more textures, one or more normal maps, and/or other information related to the systems and methods described herein.

Game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and an assets received in response to a request. In various implementations, game server 210 may be configured as a server device (e.g., having one or more server blades, processors, etc.) and/or as another device capable of providing publications and game state data related to an online game to client computer system 110.

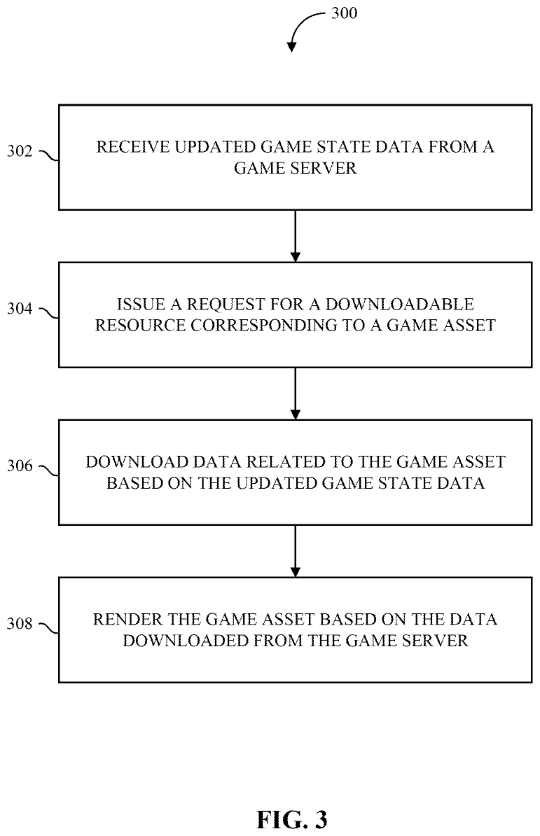

FIG. 3 illustrates an example of a process 300 for performing fast, incremental, dynamic loading of game assets, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components of client computer system 110 described in detail above.

In an operation 302, process 300 may include receiving updated game state data from a game server. In various implementations, the updated game state data may include a list of one or more game assets to be rendered within the virtual scene. In various implementations, the one or more game asset listed in the updated game state data may be downloaded from the game server as a downloadable resource comprising at least mesh data and texture data. In some implementations, operation 302 may be performed by one or more processor components the same as or similar to the processor components of client computer system 110 (shown in FIG. 1 and described herein).

In an operation 304, process 300 may include issuing a request for a downloadable resource corresponding to a game asset identified in the updated game state data. In various implementations, the request for the downloadable resource may comprise a range request. For example, in some implementations, the updated game state data may include a size map for the downloadable resource. In such implementations, a range of the range request may be determined based on the size map included in the updated game state data. In some implementations, the range of the range request may be adjusted based on a determination that a partially-cached resource corresponding to a requested game asset is accessible. In some implementations, the download request may be issued to a prioritized queue. In some implementations, a client computer system 110 may be configured to begin issuing resource requests “immediately” after receiving an updated game state. In some implementations, operation 304 may be performed by one or more processor components the same as or similar to the processor components of client computer system 110 (shown in FIG. 1 and described herein).

In an operation 306, process 300 may include downloading from the game server data related to a requested game asset based on the updated game state data. In various implementations, the game asset may comprise a computer-generated three-dimensional object. In various implementations, the game asset downloaded from the game server may be provided by the game server as a downloadable resource comprising at least mesh data and texture data for the game asset. In various implementations, the mesh data and the texture data may be organized within the downloadable resource based on levels of detail (LODs). In various implementations, the downloadable resource may comprise a progressive stream in which a mesh stream corresponding to the mesh data and a texture stream corresponding to the texture data are interleaved together. In some implementations, the mesh data and the texture data may be organized within the downloadable resource such that mesh data and texture data for a lower-quality LOD come before by mesh data and texture data for a next higher-quality LOD. In some implementations, data related to a game asset downloaded from the game server may comprise a second size map. In such implementations, whether the second size map downloaded from the game server differs from the size map included in the updated game state data may be determined, and, if the second size map does differ from the first, a second range request may be issued to the game server. In various implementations, a game asset downloaded from the game server may be provided by the game server as a downloadable resource comprising a set of game assets associated with a lower-quality LOD that are specific to one location. In some implementations, one or more game assets may be pre-loaded that are not within a virtual scene currently rendered or to be rendered but the updated game state data indicates that the one or more game assets are likely to appear. In some implementations, game assets may be provided by the game server as a downloadable resource that includes redundant data that enables a client computing system to reconstruct data in the downloadable resource not successfully received. In some implementations, the game server may offer both a CPU-intensive version of the downloadable resource and a traffic-intensive version of the downloadable resource. In such implementations, the CPU-intensive version of the downloadable resource may include one or more AVIF-encoded images, whereas the traffic-intensive version of the downloadable resource does not include any AVIF-encoded images. In some implementations, one of the CPU-intensive version of the downloadable resource and the traffic-intensive version of the downloadable resource may be selected for downloading based on a number of currently outstanding requests to decode downloadable resources. In some implementations, operation 304 may be performed by one or more processor components the same as or similar to the processor components of client computer system 110 (shown in FIG. 1 and described herein).

In an operation 308, process 300 may include rendering the game asset based on the data downloaded from the game server. In some implementations, a client computer system 110 may be configured to begin rendering one or more game assets “immediately” after receiving an updated game state. In various implementations, generic game assets for one or more three-dimensional objects may be stored prior to receiving the updated game state data. A generic (base) game asset may include a base mesh and a base texture for at least one game asset. In some implementations, a game asset may be rendered based on the updated game state data using the base mesh and the base texture. In such implementations, data downloaded from the game server may be used to render an updated version of the game asset. In some implementations, a game asset may be rendered using the base mesh and the base texture without waiting for a result of a request for download submitted based on the updated game state data. In some implementations, data related to a game asset may be downloaded in a progressive stream. In such implementations, the rendering of a game asset may be delayed until the data downloaded from the game server related to the game asset satisfies a minimum LOD. In some implementations, the minimum LOD may be selectable by a user via the client computer system. In some implementations, a downloadable resource may comprise a progressive stream and the data downloaded from the game server may include texture data. In such implementations, the texture data may recompressed into a GPU-supported format texture and/or the texture may be resized after rendering the game asset based on the data downloaded from the game server. In some implementations, game assets downloaded from the game server may be cached. For example, in some implementations, the game asset may be partially-cached such that only a portion related to a progressive stream is cached. In other implementations, the game asset may be cached as an asset in a GPU-friendly format. In some implementations, operation 308 may be performed by one or more processor components the same as or similar to the processor components of client computer system 110 (shown in FIG. 1 and described herein).

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, client computer system 110 and game server 210 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered example only, and the scope of the invention is accordingly intended to be limited only by the following claims.

What is claimed is:

1. A computer-implemented method of rendering computer-generated three-dimensional objects that are dynamically loaded based on game state data received from a game server, the method comprising:
receiving, by a client computer system, updated game state data from a game server;
downloading, by the client computer system from the game server, data related to at least one game asset based on the updated game state data, wherein the at least one game asset comprises a computer-generated three-dimensional object; and
rendering, by the client computer system, the at least one game asset based on the data downloaded from the game server.

2. The computer-implemented method of claim 1, wherein the updated game state data includes a list of one or more game assets to be rendered within the virtual scene, the list of one or more game assets including the at least one game asset.

3. The computer-implemented method of claim 1, wherein the at least one game asset downloaded from the game server is provided by the game server as a downloadable resource comprising at least mesh data and texture data for the at least one game asset.

4. The computer-implemented method of claim 3, wherein the mesh data and the texture data are organized within the downloadable resource based on levels of detail (LODs).

5. The computer-implemented method of claim 4, wherein the downloadable resource comprises a progressive stream in which a mesh stream corresponding to the mesh data and a texture stream corresponding to the texture data are interleaved together.

6. The computer-implemented method of claim 4, wherein the mesh data and the texture data are organized within the downloadable resource such that mesh data and texture data for a lower-quality LOD come before by mesh data and texture data for a next higher-quality LOD.

7. The computer-implemented method of claim 1, the method further comprising:
storing, by the client computer system, generic game assets for one or more three-dimensional objects, wherein the generic game assets include a base mesh and a base texture for the at least one game asset; and
rendering, by the client computer system, the at least one game asset based on the updated game state data using the base mesh and the base texture,
wherein the at least one game asset rendered based on the data downloaded from the game server comprises an updated version of the at least one game asset rendered using the base mesh and the base texture.

8. The computer-implemented method of claim 7, wherein the at least one game asset is rendered using the base mesh and the base texture without waiting for a result of a request for download submitted based on the updated game state data.

9. The computer-implemented method of claim 1, wherein the data related to the at least one game asset is downloaded in a progressive stream, the method further comprising delaying, by the client computer system, the rendering of the at least one game asset until the data downloaded from the game server related to the at least one game asset satisfies a minimum LOD.

10. The computer-implemented method of claim 9, wherein the minimum LOD is selectable by a user via the client computer system.

11. The computer-implemented method of claim 1, the method further comprising issuing, by the client computer system, a request for a downloadable resource corresponding to the at least one game asset.

12. The computer-implemented method of claim 11, wherein the request for the downloadable resource comprises a range request.

13. The computer-implemented method of claim 12, wherein the updated game state data includes a size map for the downloadable resource, and wherein a range of the range request is determined based on the size map included in the updated game state data.

14. The computer-implemented method of claim 13, the method further comprising adjusting, by the client computer system, the range of the range request based on a determination that a partially-cached resource corresponding to the at least one game asset is accessible.

15. The computer-implemented method of claim 13, wherein the data related to at least one game asset downloaded from the game server comprises a second size map, wherein the method further comprises:
determining, by the client computer system, whether the second size map downloaded from the game server differs from the size map included in the updated game state data; and
issuing, by the client computer system, a second range request to the game server responsive to determination that the second size map downloaded from the game server differs from the size map included in the updated game state data.

16. The computer-implemented method of claim 1, wherein the downloadable resource comprises a progressive stream and the data downloaded from the game server includes texture data, wherein the texture data is recompressed into a GPU-supported format texture after rendering the at least one game asset based on the data downloaded from the game server.

17. The computer-implemented method of claim 1, wherein the downloadable resource comprises a progressive stream and the data downloaded from the game server includes texture data, wherein the texture data is resized after rendering the at least one game asset based on the data downloaded from the game server.

18. The computer-implemented method of claim 1, wherein the at least one game asset downloaded from the game server is provided by the game server as a downloadable resource comprising a set of game assets associated with a lower-quality LOD that are specific to one location.

19. The computer-implemented method of claim 1, the method further comprising pre-loading, by the client computer system, one or more game assets that are not within a virtual scene currently rendered or to be rendered but the updated game state data indicates that the one or more game assets are likely to appear.

20. The computer-implemented method of claim 1, wherein the at least one game asset downloaded from the game server is provided by the game server as a downloadable resource, wherein the downloadable resource includes redundant data that enables the client computing system to reconstruct data in the downloadable resource not successfully received.

21. The computer-implemented method of claim 1, the method further comprising issuing, by the client computer system, a download request to a prioritized queue.

22. The computer-implemented method of claim 1, wherein the at least one game asset downloaded from the game server as a downloadable resource, wherein the game server offers a CPU-intensive version of the downloadable resource and a traffic-intensive version of the downloadable resource.

23. The computer-implemented method of claim 22, wherein the CPU-intensive version of the downloadable resource includes one or more AVIF-encoded images.

24. The computer-implemented method of claim 22, wherein the traffic-intensive version of the downloadable resource does not include one or more AVIF-encoded images.

25. The computer-implemented method of claim 22, the method further comprising selecting, by the client computer system, one of the CPU-intensive version of the downloadable resource and the traffic-intensive version of the downloadable resource based on a number of currently outstanding requests to decode downloadable resources.

26. The computer-implemented method of claim 1, the method further comprising caching, by the client computer system, the at least one game asset downloaded from the game server.

27. The computer-implemented method of claim 26, wherein the at least one game asset is partially-cached such that only a portion related to a progressive stream is cached.

28. The computer-implemented method of claim 26, wherein the at least one game asset is cached as an asset in a GPU-friendly format.

29. A system for rendering computer-generated three-dimensional objects that are dynamically loaded based on game state data received from a game server, the system comprising:
one or more processors configured by computer readable instructions to:
receive updated game state data from a game server;
download data from the game server related to at least one game asset based on the updated game state data, wherein the at least one game asset comprises a computer-generated three-dimensional object; and
render the at least one game asset based on the data downloaded from the game server.

30. The system of claim 29, wherein the updated game state data includes a list of one or more game assets to be rendered within the virtual scene, the list of one or more game assets including the at least one game asset.

31. The system of claim 29, wherein the at least one game asset downloaded from the game server is provided by the game server as a downloadable resource comprising at least mesh data and texture data for the at least one game asset.

32. The system of claim 31, wherein the mesh data and the texture data are organized within the downloadable resource based on levels of detail (LODs).

33. The system of claim 32, wherein the downloadable resource comprises a progressive stream in which a mesh stream corresponding to the mesh data and a texture stream corresponding to the texture data are interleaved together.

34. The system of claim 32, wherein the mesh data and the texture data are organized within the downloadable resource such that mesh data and texture data for a lower-quality LOD come before by mesh data and texture data for a next higher-quality LOD.

35. The system of claim 29, wherein the one or more processors are further configured to:
store generic game assets for one or more three-dimensional objects, wherein the generic game assets include a base mesh and a base texture for the at least one game asset; and
render the at least one game asset based on the updated game state data using the base mesh and the base texture,
wherein the at least one game asset rendered based on the data downloaded from the game server comprises an updated version of the at least one game asset rendered using the base mesh and the base texture.

36. The system of claim 35, wherein the at least one game asset is rendered using the base mesh and the base texture without waiting for a result of a request for download submitted based on the updated game state data.

37. The system of claim 29, wherein the data related to the at least one game asset is downloaded in a progressive stream, wherein the one or more processors are further configured to delay the rendering of the at least one game asset until the data downloaded from the game server related to the at least one game asset satisfies a minimum LOD.

38. The system of claim 37, wherein the minimum LOD is selectable by a user via the client computer system.

39. The system of claim 29, wherein the one or more processors are further configured to issue a request for a downloadable resource corresponding to the at least one game asset.

40. The system of claim 39, wherein the request for the downloadable resource comprises a range request.

41. The system of claim 40, wherein the updated game state data includes a size map for the downloadable resource, and wherein a range of the range request is determined based on the size map included in the updated game state data.

42. The system of claim 41, wherein the one or more processors are further configured to adjust the range of the range request based on a determination that a partially-cached resource corresponding to the at least one game asset is accessible.

43. The system of claim 41, wherein the data related to at least one game asset downloaded from the game server comprises a second size map, wherein the one or more processors are further configured to:
determine whether the second size map downloaded from the game server differs from the size map included in the updated game state data; and
issue a second range request to the game server responsive to determination that the second size map downloaded from the game server differs from the size map included in the updated game state data.

44. The system of claim 29, wherein the downloadable resource comprises a progressive stream and the data downloaded from the game server includes texture data, wherein the texture data is recompressed into a GPU-supported format texture after rendering the at least one game asset based on the data downloaded from the game server.

45. The system of claim 29, wherein the downloadable resource comprises a progressive stream and the data downloaded from the game server includes texture data, wherein the texture data is resized after rendering the at least one game asset based on the data downloaded from the game server.

46. The system of claim 29, wherein the at least one game asset downloaded from the game server is provided by the game server as a downloadable resource comprising a set of game assets associated with a lower-quality LOD that are specific to one location.

47. The system of claim 29, wherein the one or more processors are further configured to pre-load one or more game assets that are not within a virtual scene currently rendered or to be rendered but the updated game state data indicates that the one or more game assets are likely to appear.

48. The system of claim 29, wherein the at least one game asset downloaded from the game server is provided by the game server as a downloadable resource, wherein the downloadable resource includes redundant data that enables the client computing system to reconstruct data in the downloadable resource not successfully received.

49. The system of claim 29, wherein the one or more processors are further configured to issue a download request to a prioritized queue.

50. The system of claim 29, wherein the at least one game asset downloaded from the game server as a downloadable resource, wherein the game server offers a CPU-intensive version of the downloadable resource and a traffic-intensive version of the downloadable resource.

51. The system of claim 50, wherein the CPU-intensive version of the downloadable resource includes one or more AVIF-encoded images.

52. The system of claim 50, wherein the traffic-intensive version of the downloadable resource does not include one or more AVIF-encoded images.

53. The system of claim 50, wherein the one or more processors are further configured to select one of the CPU-intensive version of the downloadable resource and the traffic-intensive version of the downloadable resource based on a number of currently outstanding requests to decode downloadable resources.

54. The system of claim 29, wherein the one or more processors are further configured to cache the at least one game asset downloaded from the game server.

55. The system of claim 54, wherein the at least one game asset is partially-cached such that only a portion related to a progressive stream is cached.

56. The system of claim 54, wherein the at least one game asset is cached as an asset in a GPU-friendly format.
